(19) United States
(12) Patent Application Publication
(10) Pub. No.: US 2026/0181044 A1
(43) Pub. Date: Jun. 25, 2026

(54) A NETWORK-ISOLATED CONTAINER-ATTACHED STORAGE MODULE

(71) Applicant: Nutanix, Inc., San Jose, CA (US)

(72) Inventors: Sunil Khushal Patil, Pune (IN); Gaurav Barmola, Pune (IN); Shrikant Janardhan Jadhav, Pune (IN); Veeral Prabodhchandra Shah, Pune (IN)

(73) Assignee: Nutanix, Inc., San Jose, CA (US)

(21) Appl. No.: 19/287,151

(22) Filed: Jul. 31, 2025

Related U.S. Application Data
(60) Provisional application No. 63/760,893, filed on Feb. 20, 2025.

(30) Foreign Application Priority Data
Dec. 21, 2024 (IN) 202441101595

(51) Int. Cl. H04L 67/1097; H04L 9/40; H04L 67/1087

(52) U.S. Cl. CPC H04L 67/1097; H04L 63/0236; H04L 67/1091

(57) ABSTRACT

Methods, systems, and computer program products for deploying virtualized storage services. Multiple components are operatively interconnected to establish virtualized storage services implemented within a containerized computing system. These methods, systems, and computer program products implement flexible IP network access for storage I/O service handlers. Deployments comprise (1) an underlay network, the underlay network being formed of one or more routers of the cloud-provided host network and the underlay network forming an isolated namespace that is distinct from namespaces of the cloud-provided host network; (2) a container-attached storage module that is situated within the underlay network, wherein container-attached storage module operates within the isolated namespace; and (3) a network interface component that facilitates network access to the container-attached storage module via a static IP address that is configured into the network interface component. The cloud-provided host network may derive from a public cloud or a private cloud.

### RELATED APPLICATIONS

The present application claims the benefit of priority to U.S. Provisional Patent Application Ser. No. 63/760,893 titled “A NETWORK-ISOLATED CONTAINER-ATTACHED STORAGE MODULE” filed on Feb. 20, 2025, which is hereby incorporated by reference in its entirety; and the present application claims the benefit of priority to India Patent Application Ser. No. 202441101595 titled “A NETWORK-ISOLATED CONTAINER-ATTACHED STORAGE MODULE” filed on Dec. 21, 2024, which is hereby incorporated by reference in its entirety.

### TECHNICAL FIELD

This disclosure relates to cloud computing, and more particularly to techniques for a network-isolated implementation of a container-attached storage (CAS) module.

### BACKGROUND

Recent advances in containerized systems (e.g., Kubernetes) have been a boon to computing communities. Functionalities provided by such containerized systems (e.g., dealing with issues such as portability, high availability, load balancing, etc.) have made great strides in terms of ease of use and flexibilities offered. However, storage-oriented functionalities provided in off-the-shelf containerized systems such as Kubernetes (K8s) have lagged behind compute-oriented functionalities provided by containerized systems. This is especially true when it comes to storage needs that are brought to the fore by virtualized systems. What is needed are new technologies that advance the art as relates to container-oriented storage capabilities in containerized systems.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and computer program products for a network-isolated container-attached storage module, which techniques advance the relevant technologies to address technological issues with legacy approaches. More specifically, the present disclosure describes techniques used in systems, methods, and in computer program products for a network-isolated container-attached storage module. Certain embodiments are directed to technological solutions for deploying container-attached storage modules in an isolated subnet (distinct from the subnet of an encapsulating virtual private cloud).

Networking challenges and solutions for running an operating system (e.g., AOS or any virtualization system component or any virtualization hypervisor, or any operating system of any ilk) in a Kubernetes or other containerized environment are discussed in this document as well as design goals for human-computer interaction (HCl)-style networking in such containerized environments. Specifically, disclosed herein is an operating system (referred to herein as AOS or “any operating system”) as well as how such an operating system uses an underlay/native network with a minimal number of hops.

As used herein, an AOS, in whole or in part. is an operating system that is used in a hyper-converged infrastructure (HCl) platform. Such an operating system manages storage resources, compute resources, networking resources, and other virtualization systems resources both within and across clusters. In certain embodiments an AOS includes features that facilitate data deduplication and compression, snapshotting, cloning, disaster recovery (DR), security and encryption, and integration with any hypervisor that is a component of the aforesaid virtualization system.

### Network Underlay

An underlay provides a subnet that is isolated from a corresponding host network and a subnet that has a separate network namespace. Moreover, the underlay provides a subnet that hosts operating system pods. The concepts of having an isolated namespace that is separate from the overlay, and having a subnet that is separate from the overlay becomes important when one considers that in absence of an underlay, that is, using legacy techniques that implement an overlay network (e.g., by operation of a legacy network configuration of plug-ins), inefficiencies abound, not the least of which is that the host network overlay requires that every packet traverse through the overlay, which introduces unwanted latency, and which in turn demands commensurately more CPU power as well as more networking infrastructure resources to process each packet.

Embodiments as disclosed herein do not have dependencies on container networking interface plug-ins. Moreover, there are zero or minimal changes to the stack in the AOS.

The disclosed embodiments modify and improve beyond legacy approaches. In particular, the herein-disclosed techniques provide technical solutions that address the technical problems attendant to container-attached storage modules that are situated in environments that demand extremely low latency communications as well as other advanced capabilities (e.g., distributed storage capabilities). Such technical solutions involve specific implementations (e.g., data organization, data communication paths, module-to-module interrelationships, etc.) that relate to the software arts for improving computer functionality. Various applications of the herein-disclosed improvements in computer functionality serve to reduce demand for computer memory, reduce demand for computer processing power, reduce network bandwidth usage, and reduce demand for intercomponent communication.

Strictly as one example, the data structures and methods disclosed herein serve to reduce both memory usage and CPU cycles as compared to alternative approaches.

The ordered combination of steps of the embodiments serve in the context of practical applications that perform steps for deploying container-attached storage modules in an isolated subnet (distinct from the subnet of an encapsulating virtual private cloud) more efficiently. As such, techniques for deploying container-attached storage modules in an isolated subnet (distinct from the subnet of an encapsulating virtual private cloud) overcome long-standing yet heretofore unsolved technological problems associated with container-attached storage modules, which technological problems arise in the realm of computer systems.

Many of the herein-disclosed embodiments for deploying container-attached storage modules in an isolated subnet (distinct from the subnet of an encapsulating virtual private cloud) are technological solutions pertaining to technological problems that arise in the hardware and software arts that underlie public clouds. Aspects of the present disclosure achieve performance and other improvements in peripheral technical fields including, but not limited to, hyperconverged computing platform management and distributed storage systems.

Some embodiments include a sequence of instructions that are stored on a non-transitory computer readable medium. Such a sequence of instructions, when stored in memory and executed by one or more processors, causes the one or more processors to perform a set of acts for deploying container-attached storage modules in an isolated subnet (distinct from the subnet of an encapsulating virtual private cloud).

Some embodiments include the aforementioned sequence of instructions that are stored in a memory, which memory is interfaced to one or more processors such that the one or more processors can execute the sequence of instructions to cause the one or more processors to implement acts for deploying container-attached storage modules in an isolated subnet (distinct from the subnet of an encapsulating virtual private cloud).

In various embodiments, any combinations of any of the above can be organized to perform any variation of acts for a network-isolated container-attached storage module, and many such combinations of aspects of the above elements are contemplated.

Strictly as one example, consider a system for forming an underlay onto a cloud-provided host network, where the system comprises: a storage medium having stored thereon a sequence of instructions; and one or more processors that execute the sequence of instructions to cause the one or more processors to perform a set of acts, the set of acts comprising: (1) establishing an underlay network, the underlay network being formed of one or more routers of the cloud-provided host network and the underlay network forming an isolated namespace that is distinct from namespaces of the cloud-provided host network; (2) instantiating a container-attached storage module that is situated within the underlay network, wherein container-attached storage module operates within the isolated namespace; and (3) configuring a network interface component that facilitates network access to the container-attached storage module via a static IP address that is configured into the network interface component.

As other examples, consider the foregoing system wherein communication between components within the namespaces of the cloud-provided host network communicate with components within the isolated namespace via a pair of virtual ethernet interfaces (veth), and/or wherein communication between a first operating system pod of a first worker node and a second operating system pod of a second worker node communicate over the underlay network without incurring a network address translation by the one or more routers of the cloud-provided host network. As yet other examples, consider the foregoing system wherein the underlay network is a cloud-provided subnet that hosts operating system pods and wherein the cloud-provided host network hosts application pods.

Further details of aspects, objectives and advantages of the technological embodiments are described herein and in the figures and claims.

### BRIEF DESCRIPTION OF THE DRAWINGS

The drawings described below are for illustration purposes only. The drawings are not intended to limit the scope of the present disclosure.

FIG. 1A and FIG. 1B combine to illustrate and compare implementations.

FIG. 2 shows one possible implementation of an isolated container-attached storage module in the context of a virtual private cloud deployed onto cloud infrastructure, according to some embodiments.

FIG. 3A and FIG. 3B combine to illustrate and compare methods for implementing an isolated container-attached storage module in the context of a virtual private cloud, according to some embodiments.

FIG. 4 presents a flowchart that exemplifies a subnet formation technique used in systems that implement network-isolated container-attached storage modules, according to some embodiments.

FIG. 5A1 and FIG. 5A2 together constitute a multi-sheet flowchart that includes a subnet configuration technique and a namespace configuration technique as used, singly or in combination, in systems that implement network-isolated container-attached storage modules, according to some embodiments.

FIG. 6 depicts system components as arrangements of computing modules that are interconnected so as to implement certain of the herein-disclosed embodiments.

FIG. 7A, FIG. 7B, FIG. 7C, and FIG. 7D depict virtualization system architectures comprising collections of interconnected components suitable for implementing embodiments of the present disclosure and/or for use in the herein-described environments.

### DETAILED DESCRIPTION

Aspects of the present disclosure solve problems associated with using computer systems to implement container-attached storage modules having advanced capabilities. Some embodiments are directed to approaches for deploying container-attached storage modules in an isolated subnet (distinct from the subnet of, for example, an encapsulating virtual private cloud). The accompanying figures and discussions herein present example environments, systems, methods, and computer program products for a network-isolated container-attached storage module.

### Overview

In Kubernetes environments, legacy storage approaches are still used, sometimes due to familiarity, sometimes due to existing infrastructure investments, and sometimes due to certain workload requirements. These legacy storage approaches typically involve traditional storage systems like network-attached storage (NAS), storage area networks (SANs), or local disk storage that are somewhat adapted to support containerized workloads. While these systems have been enhanced to provide some degree of compatibility with Kubernetes, they remain more suited for access by static, monolithic applications rather than by dynamic, highly mobile and highly distributed workloads.

The foregoing legacy storage systems are often integrated into Kubernetes through plug-ins, drivers, or other types of adapters. For example, NAS or SAN systems present plug-ins, drivers, or other types of adapters that present persistent volumes that in turn can be accessed by containers across nodes in a cluster. These storage systems are often paired with container constructs such as Kubernetes storage classes to define the provisioning policies and access modes. Even in a Kubernetes environment that facilitates distributed storage, it sometimes happens that node-local disk storage is employed for ephemeral workloads or caching, and/or in other situations where data persistence beyond the lifecycle of a pod is not a requirement.

However, despite these adaptations and/or conveniences, legacy storage approaches in Kubernetes have many deficiencies.
Lack of Native Integration. Legacy storage solutions were not originally designed with Kubernetes in mind. Their integration often relies on third-party plug-ins or additional layers of abstraction, which can increase complexity, create performance bottlenecks, and make troubleshooting more challenging.
Scalability Challenges. Legacy systems struggle to keep up with the dynamic scaling of Kubernetes workloads. Provisioning storage for ephemeral pods or scaling persistent volumes in real time often requires manual intervention or custom scripts, which undermines Kubernetes'native automation capabilities.
Node Affinity Issues. With local disk storage, data is tied to the node where the workload runs. If a pod is rescheduled to a different node, the associated data does not follow, leading to disruptions, additional downtime, or the need for complex data replication mechanisms.
Performance Limitations. Legacy storage systems often introduce latency and throughput issues in distributed environments. For instance, NAS and SAN rely on centralized storage controllers, which can become bottlenecks under heavy loading or in the presence of high-volume containerized traffic.
Operational Complexity. Managing and maintaining legacy storage in Kubernetes environments requires specialized knowledge of both the storage systems and the Kubernetes platform. This requirement for such dual expertise can create a steep learning curve and increase operational overhead.
Cost Inefficiencies. Many legacy storage systems are designed with static workloads in mind, leading to underutilized resources in environments where workloads are constantly spun up, scaled, or shut down. Additionally, adapting legacy systems for Kubernetes often involves expensive proprietary solutions or custom integrations.

Unfortunately, the lack of native integration, the potential for port conflicts, various scalability and dependency limitations, and a bevy of operational inefficiencies render legacy approaches unsuitable to address the operational needs of modern containerized workloads. Such unsuitability becomes dire when workloads or applications or services demand high bandwidth and/or low latency network communications. The aforementioned drawbacks and unsuitability of legacy techniques drive the demand for Kubernetes-native storage solutions that are designed to handle the dynamic, distributed, and ephemeral nature of containerized environments. The problem to be solved is therefore rooted in various technological limitations of legacy approaches. Improved technologies are needed. In particular, improved applications of technologies are needed to address the aforementioned technological limitations of legacy approaches.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiment even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### DESCRIPTIONS OF EXAMPLE EMBODIMENTS

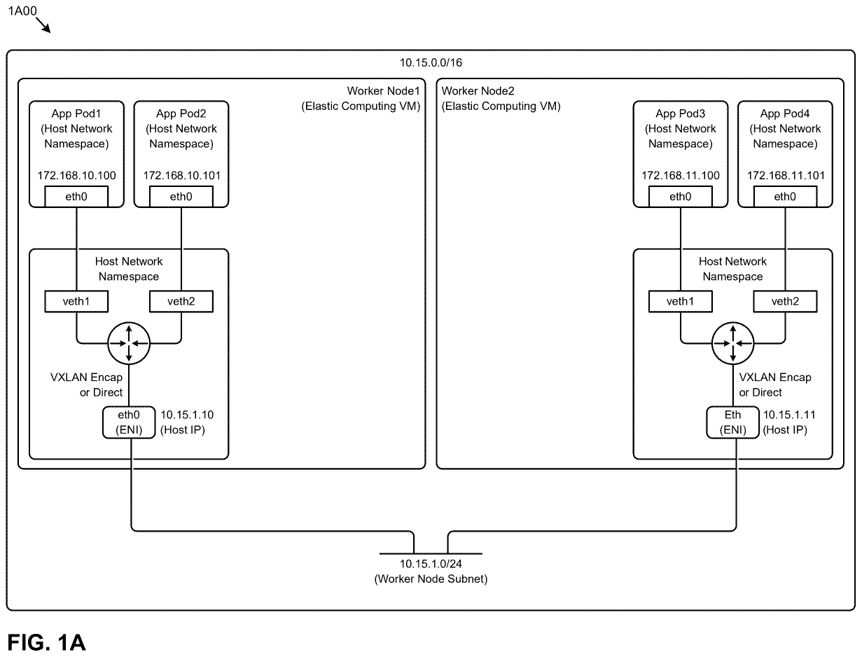

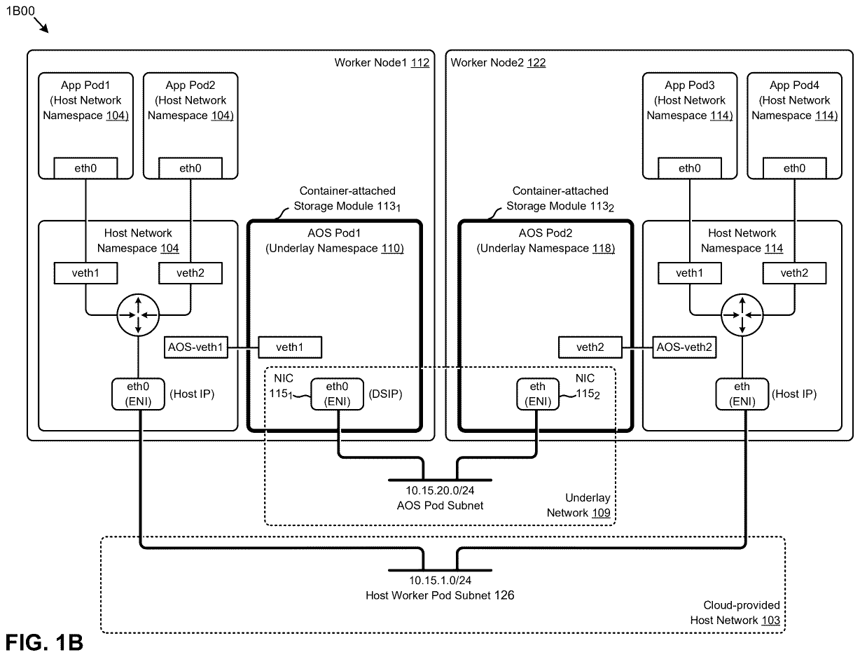

FIG. 1A and FIG. 1B combine to illustrate and compare implementations. As an option, one or more variations of implementation 1A00 and implementation 1B00 or any aspect thereof may be implemented in the context of the architecture and functionality of the embodiments described herein and/or in any environment.

FIG. 1A illustrates a high-level overview of a legacy approach to providing storage facilities in the context of a Kubernetes containerized environment. In particular, the implementation as shown in FIG. 1A employs a network overlay, an overlay namespace, and a dynamic IP address capability, whereas the embodiment of FIG. 1B employs a network underlay, a dedicated underlay namespace, and a dedicated NIC (network interface component) that is assigned a static IP address (e.g., dedicated NIC 115₁, and dedicated NIC 115₂). These concepts are discussed in turn hereunder.

### Network Overlay

A network overlay in a Kubernetes environment refers to a virtualized network architecture built on top of an existing physical network. It encapsulates network traffic using protocols such as VXLAN, GRE, and/or IP-in-IP, enabling distributed systems to communicate seamlessly while providing network isolation and scalability. This abstraction supports multi-tenancy by segmenting traffic into isolated virtual layers. However, network overlays have several disadvantages. The encapsulation and decapsulation processes introduce additional latency, which can affect system performance. Troubleshooting becomes increasingly complex due to the abstract nature of the overlay, which obscures the underlying physical network. Moreover, the encapsulation adds resource overhead to packets, consuming additional CPU and memory, especially under high network loads.

### Overlay Namespace

An overlay namespace is a logical partition within the Kubernetes environment that groups and isolates resources such as containers, network policies, and services. It supports organizational separation and enforces multi-tenancy by controlling access and configuring networks for specific namespaces. Despite these advantages, overlay namespaces pose challenges. Managing network policies and configurations across multiple namespaces can lead to inconsistencies and configuration drift. As the number of namespaces increases, the complexity of managing network traffic and resource allocation grows, potentially impacting scalability. Additionally, cross-namespace communication often requires extra configuration, which can introduce inefficiencies such as latency and bottlenecks.

### Dynamic IP Address Characteristics

Dynamic IP addressing is a mechanism in Kubernetes that allocates IP addresses to pods or services dynamically, ensuring efficient use of network resources while enabling scalability and mobility. While this approach facilitates automatic scaling, it also introduces significant disadvantages. The volatile nature of dynamically-assigned IPs can disrupt services reliant on static IPs or hardcoded configurations. Frequent changes in IP addresses necessitate constant updates to DNS records, which can delay service resolution. Moreover, some legacy load balancers or monitoring tools may not be equipped to handle dynamically-assigned IPs, resulting in compatibility issues and degraded system performance.

These limitations highlight the need for advancements in Kubernetes storage facilities and network management to address inefficiencies, reduce complexity, and ensure better performance and scalability in dynamic environments.

FIG. 1B illustrates an advancement to the legacy approach presented in FIG. 1A, specifically the addition of a network underlay with a minimal number of hops. As depicted in FIG. 1B, the network underlay is adjacent to cloud-provided host network 103, which in turn has corresponding host network namespaces (e.g., host network namespace 104 and host network namespace 114). The host worker pod subnet 126 contains two worker nodes, worker node1 112 and worker node2 122. Each worker node hosts corresponding application pod network namespaces. Specifically, worker node1 112 includes host network namespace 104 and isolated underlay namespace 110, whereas worker node2 122 includes host network namespace 114 and isolated underlay namespace 118. The operational elements in these namespaces are interconnected virtual ethernet component pairs, such as the shown pairs of virtual ethernet interfaces (e.g., veths). More specifically, yet merely as an illustrative example, app pod1 of worker node1 is connected to an operating system pod (e.g., AOS pod1) via a virtual ethernet interface (e.g., the shown AOS-veth1) which is paired with another virtual ethernet interface (veth1). As other examples, app pod3 of worker node2 is connected to an operating system pod (e.g., AOS pod2) via a virtual ethernet interface (e.g., AOS-veth2) which is paired with another virtual ethernet interface (veth2). The virtual interconnections facilitate operation of an underlay network having their own namespace, which underlay network and underlay namespace are now briefly discussed.

### Underlay Network

The addition of the underlay network 109 offers several key benefits, particularly in environments that require high-performance, reliable, and foundational connectivity. By utilizing physical networking infrastructure, such as switches, routers, and cables, the underlay delivers a direct and efficient means of data transmission without the additional overhead of encapsulation or virtualization. This results in lower latency and higher throughput, which are critical for performance-sensitive applications. The simplicity of an underlay lies in its reliance on well-established Layer 2 and Layer 3 networking protocols, making it straightforward to deploy, monitor, and troubleshoot. Additionally, the underlay's design enables robust and predictable performance as it leverages the inherent stability and efficiency of physical hardware. Unlike overlays, which may introduce abstraction layers and associated complexity, the underlay remains transparent, providing clear visibility into network operations. Furthermore, the scalability of an underlay is achieved through the addition of hardware resources, allowing organizations to handle increased traffic demands effectively.

### Underlay Namespace

The addition of the underlay allows for the dedicated underlay namespace 110 and underlay namespace 118. Having dedicated underlay namespaces offer numerous benefits by combining the performance and reliability of physical network infrastructure with the logical isolation of namespace partitioning. By operating directly on the underlay, these namespaces eliminate the overhead and latency associated with overlay networks, ensuring high-performance communication and reducing the likelihood of bottlenecks. Furthermore, they provide logical isolation for workloads, enhancing security by segregating traffic and minimizing the risk of unauthorized access or interference from other applications. This architecture allows for precise resource allocation, ensuring critical applications receive prioritized bandwidth and computational capacity, while also enabling independent scalability for different workloads without disrupting the overall system. Furthermore, troubleshooting and monitoring are simplified due to the visibility provided by the physical underlay, avoiding the complexity introduced by virtualized overlays.

Dedicated underlay namespaces also integrate seamlessly with legacy systems using traditional networking protocols, ensuring compatibility and smooth operation in hybrid environments. By eliminating unnecessary abstraction layers, underlay namespaces reduce routing/configuration complexity, making the network easier to manage and maintain. This configuration is particularly advantageous for distributed systems, such as Kubernetes, where performance, security, and scalability are critical for supporting high-priority applications.

### Dedicated Network Interface Component (NIC) With Pre-Allocated IP Addresses

The deployment of a dedicated network interface component (NIC) with pre-allocated IP addresses (e.g., a static IP address) offers significant benefits within networked systems, particularly in environments requiring high reliability, consistent performance, and streamlined communication. By assigning a fixed and unchanging IP address to a dedicated NIC, the configuration ensures predictable network routing, which facilitates stable and reliable connections to critical services or devices. This setup eliminates dependency on dynamic allocation mechanisms, such as dynamic host configuration protocol (DHCP), thereby reducing the risk of address conflicts or unavailability during peak operational periods. The isolation of traffic to a dedicated NIC further enhances performance by mitigating contention with other services and optimizing resource utilization.

Additionally, the pre-allocated/fixed IP address (e.g., a static IP address) simplifies the configuration of ancillary systems, including firewalls, load balancers, and DNS records by providing a consistent endpoint for communication. This predictability not only improves operational efficiency but also enhances security, as traffic directed through the dedicated NIC can be closely monitored and restricted to authorized channels. Such an architecture is particularly advantageous in distributed computing environments, such as Kubernetes, where it supports stable node-to-node communication, isolates management traffic, and ensures uninterrupted access to high-priority services, thus contributing to the robustness and scalability of the overall system. Moreover, in the case of the aforementioned distributed computing environments, pre-allocated IP addresses can be used in the context of the herein-disclosed deployments so as to exploit the architectural features of the networking and computing environment.

As used herein, a data services IP (DSIP) address is a floating IP address that provides a single point of access for storage-related services. Its use ensures that storage traffic remains accessible even if nodes or node controllers fail. Use of a DSIP facilitates centralized storage access by providing a single IP address for connecting applications to storage services. In operation, a DSIP address can be dynamically reassigned to a healthy node (or subsystem) in the event of some failure or other loss of facility. In the context of the herein-disclosed deployments, external clients use the DSIP address rather than either (1) managing multiple storage endpoints, or (2) tracking multiple controller IP addresses.

Pre-allocated/fixed IP addresses (e.g., static IP addresses) can be drawn from any corpus of such IP addresses. Strictly as an example, a fixed IP address can be drawn from a dataset of pre-allocated and published IP addresses. Moreover, fixed IP addresses need not necessarily comport with the strict definition of a static IP address. Rather, the sense of a fixed IP address is that it does not change during the lifetime of when traffic is directed through the aforementioned dedicated NIC.

Further details regarding general approaches to dealing with static IP addresses when deploying container-attached storage components are described in U.S. patent application Ser. No. 19/195,345 Titled “dynamically-assigned Ip Addresses for Executable CONTAINER COMPONENTS” filed on Apr. 30, 2025, which is hereby incorporated by reference in its entirety.

### Container-Attached Storage Module

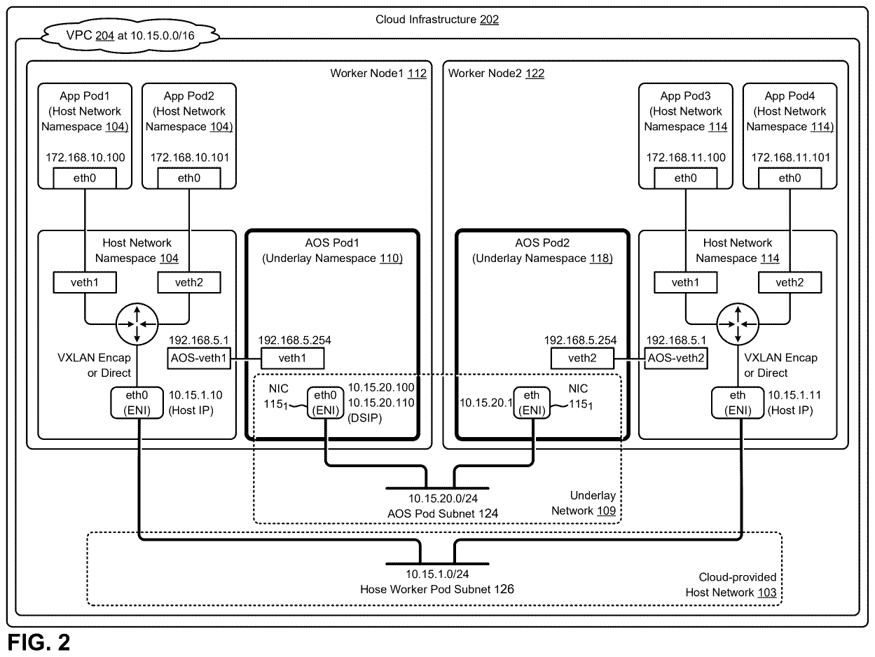

Any number of isolated instances of a container-attached storage module (e.g., container-attached storage module 113₁, and container-attached storage module 113₂) can be deployed in the context of a virtual private cloud deployed onto public or private cloud infrastructure, and can be configured using the foregoing isolation techniques. One possible implementation of an isolated container-attached storage module in the context of a virtual private cloud is shown and described as pertains to FIG. 2. More specifically, container-attached storage functions can be implemented, in whole or in part, into the AOS pod(s).

Further details regarding general approaches to implementing container-attached storage are described in U.S. patent application Ser. No. 18/791,271 titled “CONTAINERIZED CLOUD-NATIVE CLUSTER STORAGE TARGETS” filed on Jul. 31, 2024, which is hereby incorporated by reference in its entirety.

As used herein, the term “container-attached storage” or “container-attached storage module” or “container-attached storage facility” (sometimes abbreviated as “CAS” or “nuCAS”) is a software-defined storage capability that is Kubernetes native and is deployed as one or more storage controllers that run as containerized services or as microservices. Storage platforms that use one or more container-attached storage facilities provide an app-centric approach for storage administration where application administrators and/or corresponding developers set their storage, back-up, and DR policies, performance QoS requirements, and replication patterns as if the application has its independent storage engine under the ownership of the application administrator. One CAS architecture proposes using the operating system services (e.g., intra-OS services or sidecar services) to build a storage platform where the operating system instances run as Kubernetes pods.

As discussed hereunder, the Kubernetes platform could be running in an on-premises environment or could be running in/on a cloud. In many cases the embodiments use custom resource definitions (CRDs) to represent low-level storage resources, enabling storage to be seamlessly integrated with cloud storage resources and tools. Similar to hyperconverged systems, where one can add nodes having constituent control virtual machines (CVMs) and virtual disks (vDisks) that incrementally add compute and storage to handle application load increases, the storage and performance of a volume in a CAS system must be scalable. As the number of container applications increase in a given Kubernetes cluster, more compute and/or storage resources can be added to the Kubernetes cluster to increase overall capacity and availability in a network-and namespace-isolated environment. Autonomous scheduling could be used to ensure that the application pod and its primary storage copy reside on the same compute node to provide better latency and throughput.

FIG. 2 shows one possible implementation of an isolated container-attached storage module in the context of a virtual private cloud deployed onto cloud infrastructure 202. As an option, one or more variations of isolated container-attached storage module or any aspect thereof may be implemented in the context of the architecture and functionality of the embodiments described herein and/or in any environment.

The figure is being presented to illustrate how an isolated container-attached storage module might be configured to operate in environments having virtual private clouds (e.g., virtual private clouds (e.g., VPC 204) deployed within a cloud infrastructure using the foregoing isolations techniques.

More specifically, AOS pods that include container-attached storage functions can be deployed into the underlay. The shown AOS pod subnet 124 connects AOS pod1 to AOS pod2 such that when a request for some particular storage item (e.g., a block of storage) is received at AOS pod1, it can either be handled by AOS pod1 if the requested storage item is resident at worker node1 112, or, in the case that the particular storage item is actually resident at worker node2 122, then the request can be redirected to worker node2 122 using the underlay formed using the AOS pod subnet 124.

### Dedicated Network Interface Component (NIC) With a Static IP Address

As heretofore disclosed, the deployment of a dedicated network interface component (NIC) with a static IP address offers significant benefits within networked systems, particularly in environments requiring high reliability, consistent performance, and streamlined communications. In this case, by assigning a fixed and unchanging IP address to a dedicated NIC that serves the underlay, the configuration ensures predictable network routing, which in turn facilitates stable and reliable connections to critical services (e.g., container-attached storage services).

As can now be appreciated, when an app pod (e.g., app pod1 client in host network namespace 104) uses a disk/volume provided by AOS (e.g., any storage accessible by an AOS pod, such as the AOS pod within underlay namespace 110), the client (e.g., iSCSI client running in the host network namespace 104) connects to the AOS pod via a veth pair, rather than by traversing a route following the ENI path. This avoids the inefficient scenario where network packets would have to egress from the host ENI and then be received on the AOS ENI. This serves to optimize local communication between an app pod (e.g., an iSCSI client) and an AOS pod.

Emphatically, as can now be seen, network communications between AOS pod1 and AOS pod2 occurs directly (e.g., over AOS pod subnet 124) without any additional hops. In contrast, with general purpose CNI plug-ins, communication between pods (such as app pod1 and app pod3) typically traverses the host network namespace on both the sending and receiving sides, introducing two extra hops and thereby deleteriously reducing efficiency. For AOS pods, since packets do not pass through the host network namespace, these additional hops are eliminated.

The foregoing discussion of FIG. 2 pertains to merely some possible embodiments and/or ways to implement an isolated container-attached storage module. Many variations are possible, for example, the isolated container-attached storage module as comprehended in the foregoing can be implemented in any environment, one example of which is shown and described as pertains to the following figures.

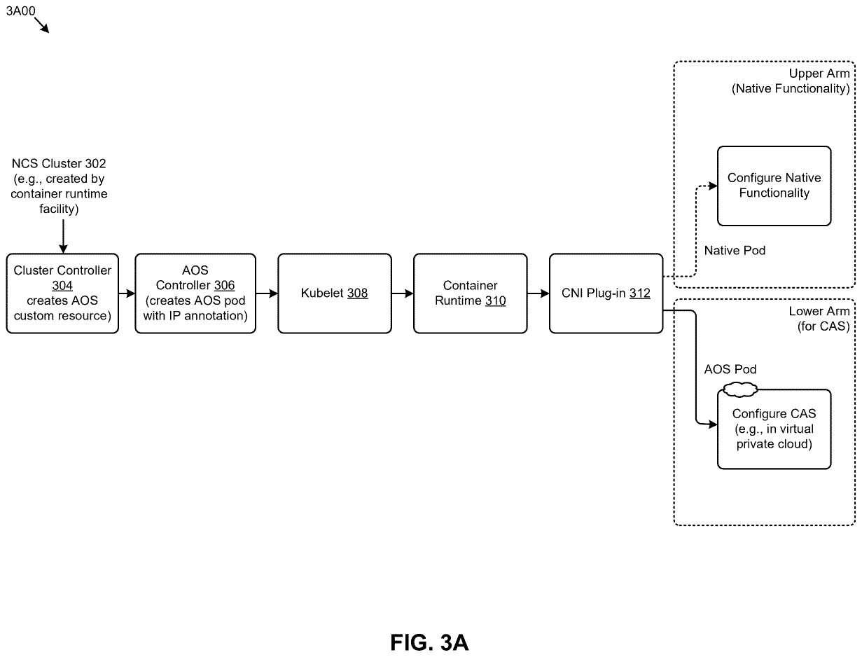

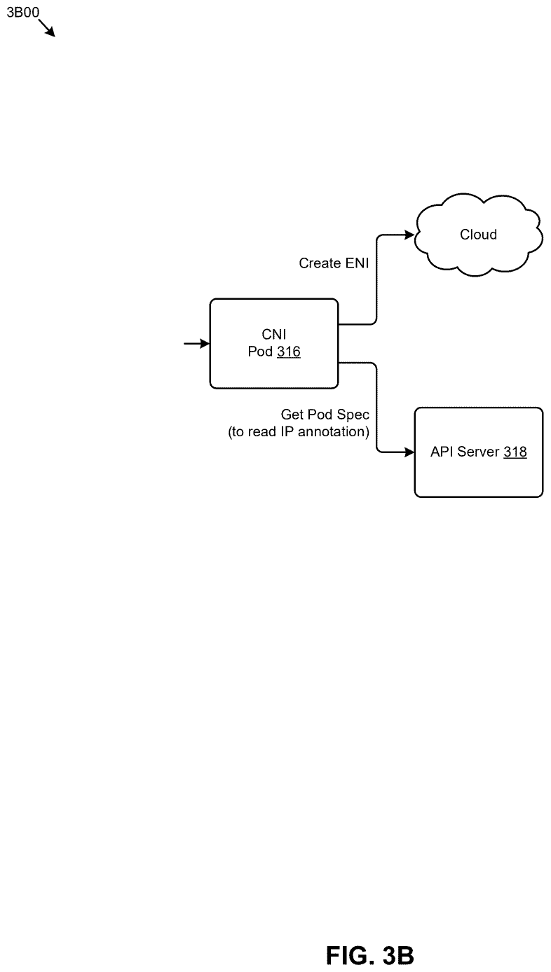

FIG. 3A and FIG. 3B combine to illustrate and compare methods for implementing an isolated container-attached storage module in the context of a virtual private cloud. As an option, one or more variations of method 3A00 and method 3B00 or any aspects thereof may be implemented in the context of the architecture and functionality of the embodiments described herein and/or in any environment.

The figures are being presented to illustrate how different methods might be configured to operate in different environments comprising container-attached storage modules.

The left portion of FIG. 3A plus the upper arm of FIG. 3A depict a flow that leads up to instantiation of a containerized system's container networking interface (CNI). This flow, including the upper arm, is used to configure native pods (e.g., the application pods of FIG. 2). The lower arm is used to configure AOS pods. More particularly, this lower arm facilitates configuration of AOS pods in an underlay having its own namespace and having a dedicated NIC with a static IP address. Further aspects of this sort of configuration are shown and described as pertains to FIG. 3B.

Now returning to the left portion of FIG. 3A, the flow is initiated upon advice of the existence of a containerized system cluster (e.g., an NCS cluster 302), which advice causes instantiation of a cluster controller (step 304). Similarly, upon advice of the existence of a containerized system cluster an operating system (e.g., AOS), a cluster controller is instantiated (step 306). Next, a node agent, possibly embodied as an executable container, or as some other executable container system entity (e.g., the shown Kubelet 308) is instantiated on each node of the cluster. This in turn provides the environment in which an executable runtime module (e.g., the shown container runtime 310) can execute. Furthermore, the foregoing steps provide the environment in which a plug-in (e.g., CNI plug-in 312) can execute.

FIG. 3B depicts one way that any of the foregoing ethernet interfaces can be configured into a (public or private) cloud infrastructure. More particularly, in some embodiments, a service account for a container networking interface plug-in that includes a CNI operator can create a service account for a container networking interface plug-in. Such a CNI operator might be used to associate various cloud infrastructure with this service account. As an example, such a service account can be used to authenticate API calls.

In spite of the complexities of a networking underlay, by using the herein-disclosed CNI-enabled facilities, there are many ways for networking components and/or their interfaces to be configured—regardless of whether the deployment is onto a public cloud (e.g., onto a public cloud infrastructure) or onto a private cloud (e.g., onto an on-prem private cloud infrastructure). One possible way is to use a container networking interface plug-in that includes support for both a native configuration path as well as a custom container-attached storage module configuration path. Such support can be implemented as shown using two arms of possible processing flow. In this example flow, a CNI pod 316 is able to handle creation of an ENI in a public cloud. Additionally or alternatively, the CNI pod might query (e.g., to an API server 318) to get an IP address. Any known technique can be used to formulate the query; for example, a pod specification might be accessed/queried so as to determine the sought-after IP configuration.

In some embodiments, a CNI pod can dynamically raise a query to any sort of listening server that is configured for retrieving the specifications and/or custom resources of an entity so as to determine which IP address to assign to which network components. This in turn facilitates deployment of a fully-automated, policy-driven network configuration that can easily integrate with either commercially-available IP address management solutions and/or custom resources, thus making the network setup flexible and adaptable within any conceivable containerized system of any provenance or configuration.

The foregoing discussion of FIG. 3A and FIG. 3B pertains to merely some possible embodiments and/or ways to implement the foregoing methods. Many variations or extensions are possible. For example, the methods as comprehended in the foregoing can be augmented by a subnet formation flow, one example of which is shown and described as pertains to the following figure.

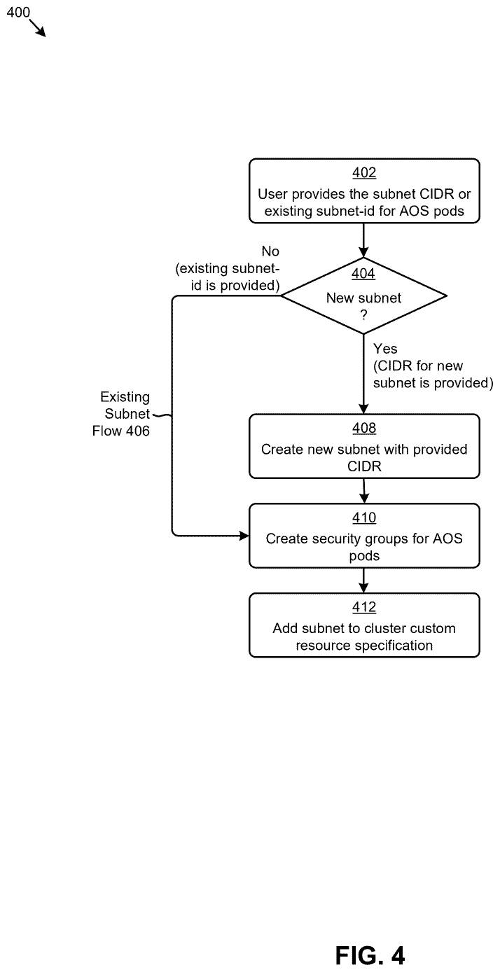

FIG. 4 presents a flowchart that exemplifies a subnet formation technique used in systems that implement network-isolated container-attached storage modules. As an option, one or more variations of subnet formation technique 400 or any aspect thereof may be implemented in the context of the architecture and functionality of the embodiments described herein and/or in any environment.

As depicted in the flowchart, the process begins with the user providing either the subnet classless inter-domain routing (CIDR) ID, or an existing subnet ID for the AOS pods (step 402). The user (or automated agent) then decides whether a new subnet is required (by taking the “Yes” branch of decision 404). If the user (or automated agent) selects “Yes,” a CIDR is specified for the new subnet (step 408). Following this, the deployment process creates security groups for the AOS pods (step 410) and subsequently adds the subnet CIDR to the cluster's custom resource specification. Conversely, if the user or agent indicates that a new subnet is not needed (by taking the “No” branch of decision 404), the flowchart directs the process to proceed with the existing subnet (flow 406) to step 410, whereafter the process moves on to create security groups for the AOS pods and concludes with adding the subnet CIDR to the cluster's custom resource specification (step 412).

The foregoing discussion of FIG. 4 pertains to merely some possible embodiments and/or ways to implement a subnet formation technique. Many variations are possible, for example, as shown and described as pertains to the following figure.

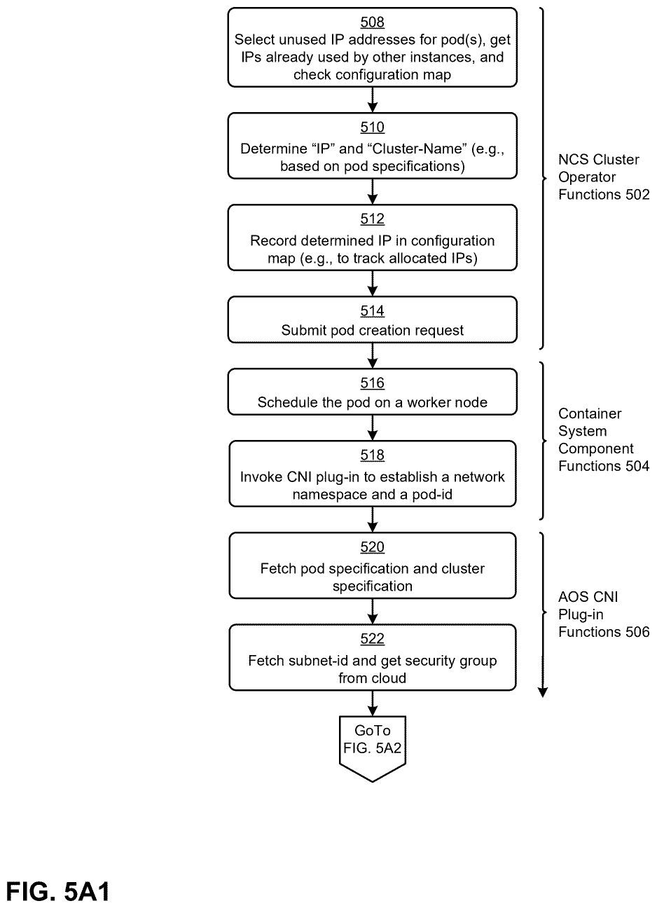

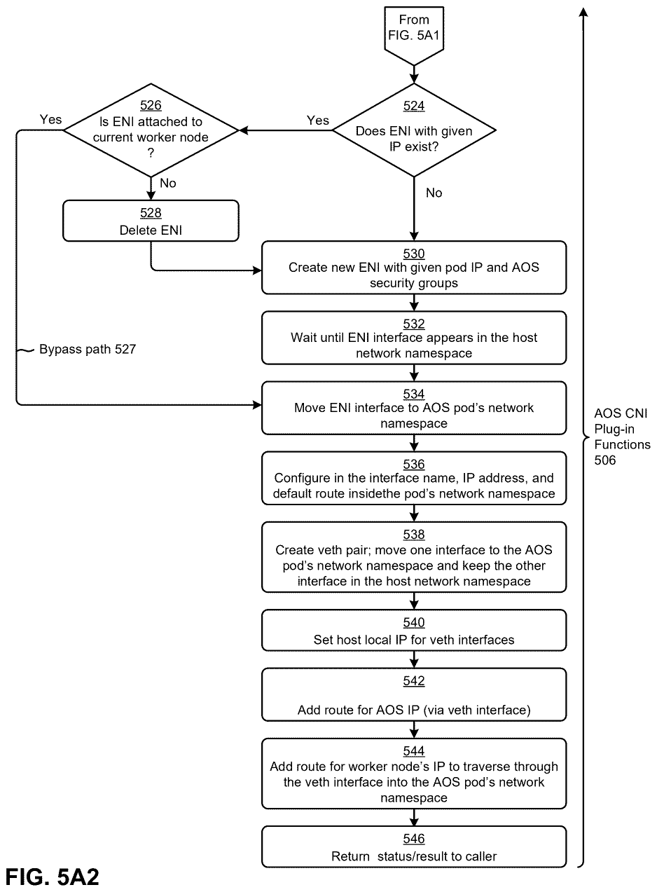

FIG. 5A1 and FIG. 5A2 together constitute a multi-sheet flowchart that includes a subnet configuration technique and a namespace configuration technique as used, singly or in combination, in systems that implement network-isolated container-attached storage modules.

FIG. 5A1 is being presented to illustrate how to configure a subnet that is configured to operate in a cloud environment, whereas FIG. 5A2 is being presented to illustrate how a separate subnet offers the networking constructs to be able to implement an isolated namespace.

### Define or Determine Partitioning of the Operations

In some cases, the container system itself offers a facility (e.g., an API) to perform certain of the operations. In this situation, some portion of the partitioning may be implied by virtue of the host container system component functions 504 (e.g., Kubernetes container system components). Then, by process of elimination or by default, others of the operations are assigned to other components. In the example shown, some operations are assigned as steps/operations of a CNI plug-in (e.g., as AOS CNI plug-in functions 506), and yet other operations are assigned as steps/operations of a cluster operator (e.g., NCS cluster operator functions 502).

Top-to-Bottom Configuration Path

To begin and pursue assessment/discovery, an unused IP address available for pod(s) is selected. For example, (1) IPs already in use by other instances are obtained and/or checked by an IP configuration map (step 508), (2) determine “IP” and “Cluster-Name” such as may possibly be found in pod specifications (step 510), and (3) record the determined IP(s) in a configuration map or by using some other means to record allocated IP addresses (step 512).

Now, with the assessment/discovery complete, submit a pod creation request to the container system, possibly via an API call (step 514) and schedule the created pod on a worker node (step 516).

### CNI Plug-In Operations

Any appropriate one of the container system runtime components invokes an AOS CNI plug-in, which invocation provides the container system with an underlay network namespace and a pod-id (step 518). Next, the pod specification and cluster specification (step 520) are fetched from the container system (e.g., from K8s API server), then the subnet-id (for a given CIDR) and security group are fetched from the cloud infrastructure (step 522).

### Bring the ENI and VETH to Bear

A question with the semantics of, “Does an ENI with given IP exist?” (decision 524) is posed and answered. If “Yes” then it needs to be determined (at decision 526) if the ENI is already attached to a current worker node. If not (the “No” branch of decision 526), then delete the ENI (step 528) as a step toward creating a new ENI and assignment to a pod (step 530) which, after a short time for the system to propagate/settle, the assignment is confirmed (step 532). On the other hand, if the ENI is already attached to a current worker node (the “Yes” branch of decision 526), bypass path 527 is taken, in which case, the ENI is merely moved into the newly-created pod's namespace (step 534). This approach ensures efficient ENI management, reduces unnecessary ENI creation, and minimizes pod restart times by reusing existing ENIs whenever possible.

Returning to the “No” branch of decision 524, create a new ENI and assignment to a pod (step 530) which, after a short time for the system to propagate/settle, the assignment is confirmed (step 532) and the ENI is moved into the newly-created pod's namespace (step 534).

From here, there are various bookkeeping and configuration steps to accomplish. Specifically, next steps include to configure in the interface name, IP address, and default route inside the pod's network namespace (step 536); create a veth pair; move one interface to the pod's network namespace and keep the other interface in the host network's namespace (step 538); and establish host local IP addresses into the veth interfaces (step 540). To finish the flow, add a route for the AOS IP to traverse through the veth interface in the host network namespace (step 542) and add a route for the worker node's IP to traverse through the veth interface in the AOS pod's network namespace (step 544), then return a result (e.g., “success indication”) to the container runtime caller (step 546).

The foregoing presentation of FIG. 5A1 and FIG. 5A2 pertain to merely some possible embodiments and/or ways to establish subnet and/or namespace configurations. Many variations are possible.

### SYSTEM ARCHITECTURE OVERVIEW

### Additional System Architecture Examples

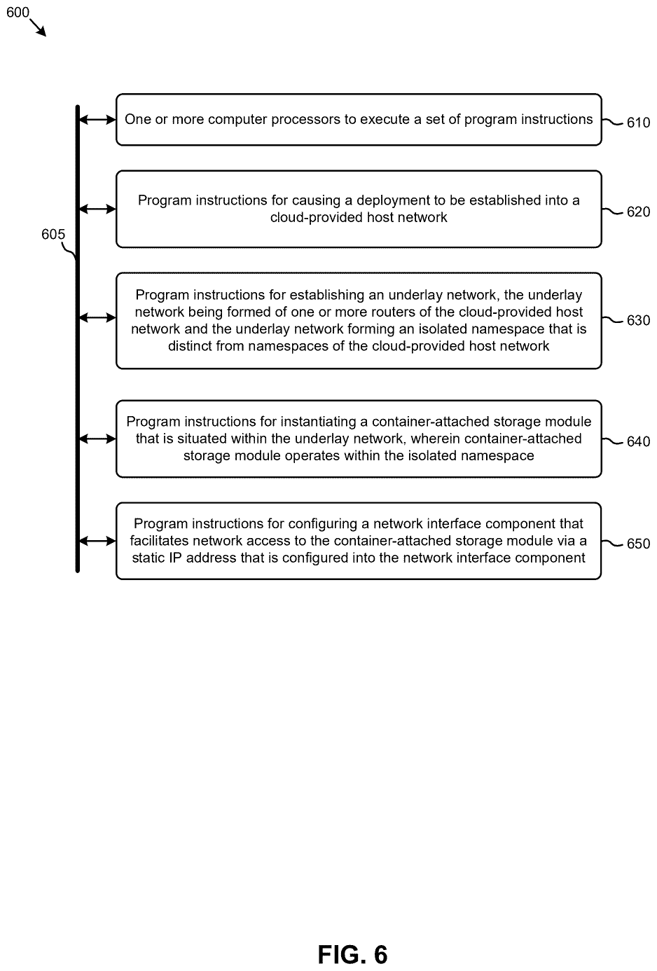

FIG. 6 depicts system 600 as an arrangement of computing modules that are interconnected so as to operate cooperatively to implement certain of the herein-disclosed embodiments. This and other embodiments present particular arrangements of elements that, individually or as combined, serve to form improved technological processes. The partitioning of system 600 is merely illustrative and other partitions are possible.

FIG. 6 depicts a block diagram of a system. As an option, system 600 may be implemented in the context of the architecture and functionality of the embodiments described herein. Of course, however, system 600 or any operation therein may be carried out in any desired environment.

The system 600 comprises at least one processor and at least one memory, the memory serving to store program instructions corresponding to the operations of the system. As shown, an operation can be implemented in whole or in part using program instructions accessible by a module. The modules are connected to a communication path 605, and any operation can communicate with any other operation(s) over communication path 605. The modules of the system can, individually or in combination, perform method operations within system 600. Any operations performed within system 600 may be performed in any order unless as may be specified in the claims.

The shown embodiment implements a portion of a computer system, presented as system 600, comprising one or more computer processors to execute a set of program code instructions (module 610) and modules for accessing memory to hold program code instructions to perform acts for: causing a deployment to be established into a cloud-provided host network (module 620); establishing an underlay network, the underlay network being formed of one or more routers of the cloud-provided host network, and the underlay network forming an isolated namespace that is distinct from namespaces of the cloud-provided host network (module 630); instantiating a container-attached storage module that is situated within the underlay network, wherein container-attached storage module operates within the isolated namespace (module 640); and configuring a network interface component that facilitates network access to the container-attached storage module via a static IP address that is configured into the network interface component (module 650).

Variations of the foregoing may include more or fewer of the shown modules. Certain variations may perform more or fewer (or different) steps and/or certain variations may use data elements in more, or in fewer, or in different operations.

Still further, some embodiments include variations in the operations performed, and some embodiments include variations of aspects of the data elements used in the operations.

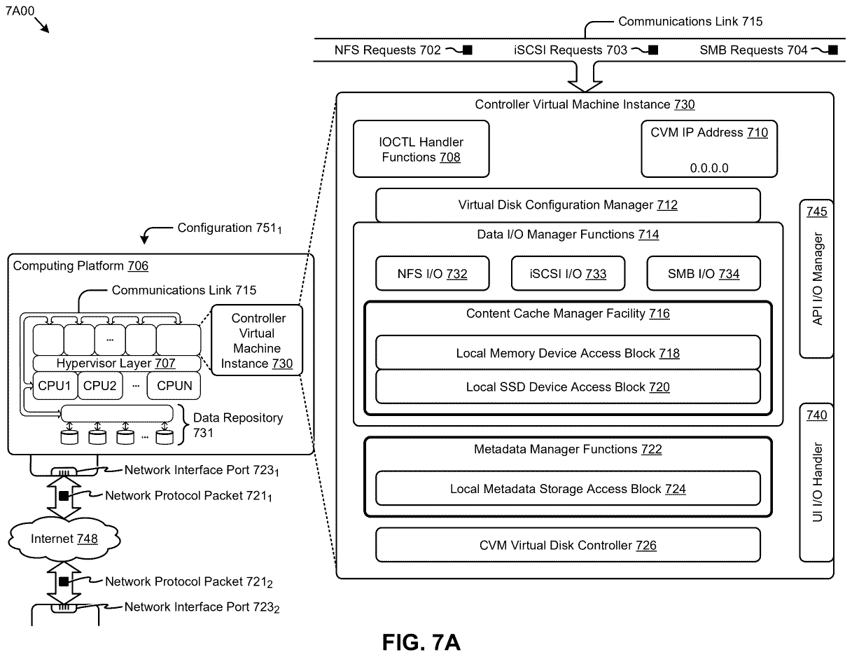

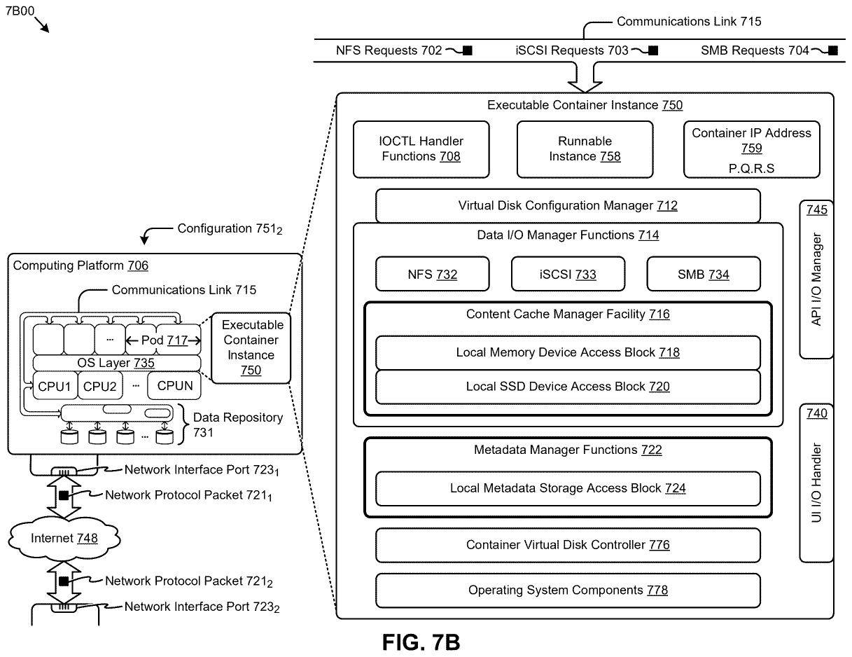

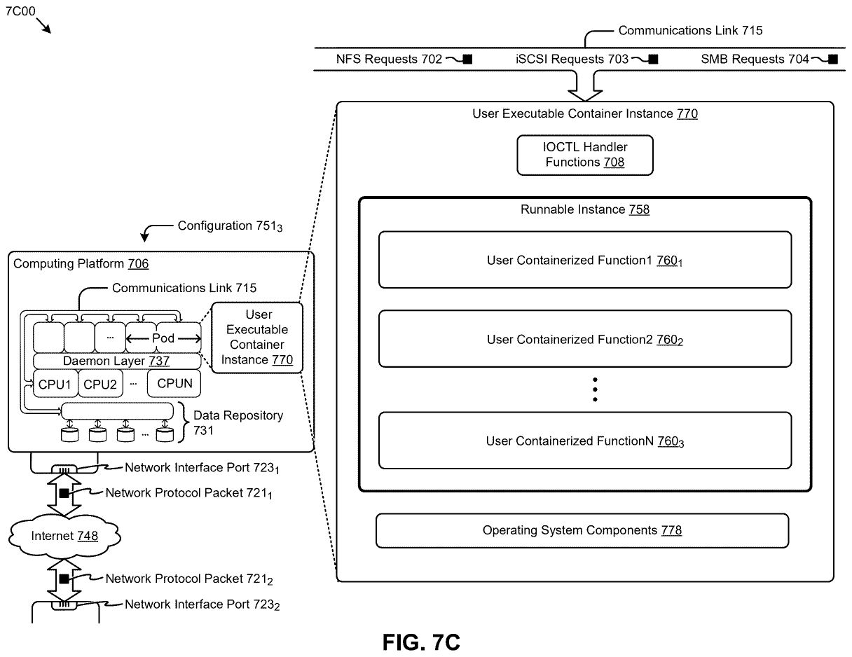

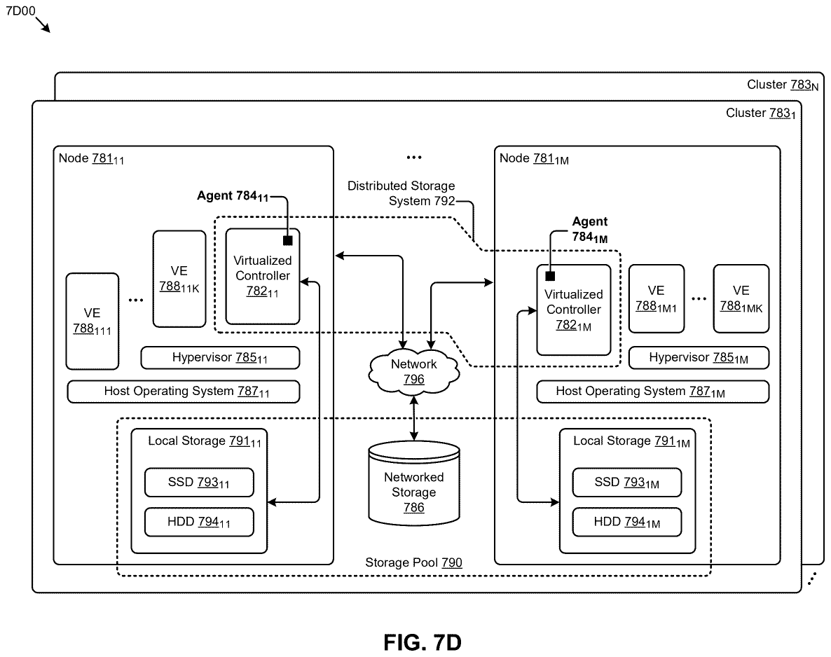

All or portions of any of the foregoing techniques can be partitioned into one or more modules and instanced within, or as, or in conjunction with, a virtualized controller in a virtual computing environment. Some example instances of virtualized controllers situated within various virtual computing environments are shown and discussed as pertains to FIG. 7A, FIG. 7B, FIG. 7C, and FIG. 7D.

FIG. 7A depicts a virtualized controller as implemented in the shown virtual machine architecture 7A00. The heretofore-disclosed embodiments, including variations of any virtualized controllers, can be implemented in distributed systems where a plurality of networked-connected devices communicate and coordinate actions using inter-component messaging.

As used in these embodiments, a virtualized controller is a collection of software instructions that serve to abstract details of underlying hardware or software components from one or more higher-level processing entities. A virtualized controller can be implemented as a virtual machine, as an executable container, or within a layer (e.g., such as hypervisor layer 707). Furthermore, as used in these embodiments, distributed systems are collections of interconnected components that are designed for, or dedicated to, storage operations as well as being designed for, or dedicated to, computing and/or networking operations.

Interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities. Strictly as one example, in a deployment onto/into a cloud-provided host network, pairs of components are configured to communicate over the underlay network—without incurring a network address translation (NAT). As such, and in actual operational situations, communication between components (e.g., communication between a first AOS pod of a first worker node and a second AOS pod of a second worker node) can be carried out where at least some of the inter-component communications (e.g., high-bandwidth and/or low latency communications) over the underlay network occur without involving a network address translation (e.g., without needing a network address translation to be carried out by the one or more routers of the cloud-provided host network). It should be noted that an underlay network can be formed from network components that are configured to form a cloud-provided subnet that is dedicated to AOS pods.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, computing and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system (OS) virtualization techniques are combined.

As shown, virtual machine architecture 7A00 comprises a collection of interconnected components suitable for implementing embodiments of the present disclosure and/or for use in the herein-described environments. Moreover, virtual machine architecture 7A00 includes a controller virtual machine instance 730 in configuration 751₁ that is further described below as pertaining to implementation of such a controller virtual machine instance 730. Configuration 751₁ supports virtual machine instances that are deployed as user virtual machines, or controller virtual machines or both. Such virtual machines interface with a hypervisor layer (as shown). Some virtual machines are configured to process storage inputs or outputs (I/O or IO) as received from any or every source within the computing platform. An example implementation of such a virtual machine that processes storage I/O is depicted as 730.

In this and other configurations, a controller virtual machine instance receives block I/O storage requests as network file system (NFS) requests in the form of NFS requests 702, and/or internet small computer system interface (iSCSI) block IO requests in the form of iSCSI requests 703, and/or Samba file system (SMB) requests in the form of SMB requests 704. The controller virtual machine (CVM) instance publishes and responds to an internet protocol (IP) address (e.g., CVM IP address 710). Various forms of input and output can be handled by one or more IO control (IOCTL) handler functions (e.g., IOCTL handler functions 708) that interface to other functions such as data IO manager functions 714 and/or metadata manager functions 722. As shown, the data IO manager functions can include communication with virtual disk configuration manager 712 and/or can include direct or indirect communication with any of various block IO functions (e.g., NFS 732, iSCSI 733, SMB 734, etc.).

In addition to block IO functions, configuration 751₁ supports input or output (IO) of any form (e.g., block IO, streaming IO) and/or packet-based IO such as hypertext transport protocol (HTTP) traffic, etc., through either or both of a user interface (UI) handler such as UI IO handler 740 and/or through any of a range of application programming interfaces (APIs), possibly through API IO manager 745.

Communications link 715 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, the detail of controller virtual machine instance 730 includes content cache manager facility 716 that accesses storage locations, possibly including local dynamic random access memory (DRAM) (e.g., through local memory device access block 718) and/or possibly including accesses to local solid state storage (e.g., through local SSD device access block 720).

Common forms of computer readable media include any non-transitory computer readable medium, for example, floppy disk, flexible disk, hard disk, magnetic tape, or any other magnetic medium; compact disk read-only memory (CD-ROM) or any other optical medium; punch cards, paper tape, or any other physical medium with patterns of holes; or any random access memory (RAM), programmable read-only memory (PROM), erasable programmable read-only memory (EPROM), flash memory EPROM (FLASH-EPROM), or any other memory chip or cartridge. Any data can be stored, for example, in any form of data repository 731, which in turn can be formatted into any one or more storage areas, and which can comprise parameterized storage accessible by a key (e.g., a filename, a table name, a block address, an offset address, etc.). Data repository 731 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 724. The data repository 731 can be configured using CVM virtual disk controller 726, which can in turn manage any number or any configuration of virtual disks.

Execution of a sequence of instructions to practice certain embodiments of the disclosure are performed by one or more instances of a software instruction processor, or a processing element such as a central processing unit (CPU) or data processor or graphics processing unit (GPU), or such as any type or instance of a processor (e.g., CPU1, CPU2, . . . , CPUN). According to certain embodiments of the disclosure, two or more instances of configuration 751₁ can be coupled by communications link 715 (e.g., backplane, local area network, public switched telephone network, wired or wireless network, etc.) and each instance may perform respective portions of sequences of instructions as may be required to practice embodiments of the disclosure.

The shown computing platform 706 is interconnected to the Internet 748 through one or more network interface ports (e.g., network interface port 723₁ and network interface port 723₂). Configuration 751₁ can be addressed through one or more network interface ports using an IP address. Any operational element within computing platform 706 can perform sending and receiving operations using any of a range of network protocols, possibly including network protocols that send and receive packets (e.g., network protocol packet 721₁ and network protocol packet 721₂).

Computing platform 706 may transmit and receive messages that can be composed of configuration data and/or any other forms of data and/or instructions organized into a data structure (e.g., communications packets). In some cases, the data structure includes program instructions (e.g., application code) communicated through the Internet 748 and/or through any one or more instances of communications link 715. Received program instructions may be processed and/or executed by a CPU as it is received and/or program instructions may be stored in any volatile or non-volatile storage for later execution. Program instructions can be transmitted via an upload (e.g., an upload from an access device over the Internet 748 to computing platform 706). Further, program instructions and/or the results of executing program instructions can be delivered to a particular user via a download (e.g., a download from computing platform 706 over the Internet 748 to an access device).

Configuration 751₁ is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (LAN) and/or through a virtual LAN (VLAN) and/or over a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

As used herein, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to a network-isolated container-attached storage module. In some embodiments, a module may include one or more state machines and/or combinational logic used to implement or facilitate the operational and/or performance characteristics pertaining to a network-isolated container-attached storage module.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of a network-isolated container-attached storage module). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to a network-isolated container-attached storage module, and/or for improving the way data is manipulated when performing computerized operations pertaining to deploy container-attached storage modules in an isolated subnet (distinct from the subnet of an encapsulating virtual private cloud).

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT” issued on Oct. 1, 2013, which is hereby incorporated by reference in its entirety.

FIG. 7B depicts a virtualized controller implemented by containerized architecture 7B00. The containerized architecture comprises a collection of interconnected components suitable for implementing embodiments of the present disclosure and/or for use in the herein-described environments. Moreover, the shown containerized architecture 7B00 includes an executable container instance 750 in configuration 751₂ that is further described below as pertaining to executable container instance 750. Configuration 751₂ includes an operating system layer (the shown OS layer 735) that performs addressing functions such as providing access to external requestors (e.g., user virtual machines or other processes) via an IP address 759 (e.g., “P.Q.R.S”, as shown). Providing access to external requestors can include implementing all or portions of a protocol specification, possibly including the hypertext transport protocol (HTTP or “http:”) and/or possibly handling port-specific functions. In this and other embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

An operating system layer (e.g., the shown OS layer 735) can perform port forwarding to any executable container (e.g., executable container instance 750). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a corresponding virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “ls”, “dir”, etc.). The executable container might optionally include operating system components 778, however such a separate set of operating system components need not be provided. As an alternative, an executable container can include runnable instance 758, which is built (e.g., through compilation and linking, or just-in-time compilation, etc.) to include any or all of any or all library entries and/or operating system (OS) functions, and/or OS-like functions as may be needed for execution of the runnable instance. In some cases, a runnable instance can be built with a virtual disk configuration manager, any of a variety of data IO management functions, etc. In some cases, a runnable instance includes code for, and access to, container virtual disk controller 776. Such a container virtual disk controller can perform any of the functions that the aforementioned CVM virtual disk controller 726 can perform, yet such a container virtual disk controller does not rely on a hypervisor or any particular host operating system so as to perform its range of functions.

In some environments, multiple executable containers can be collocated and/or can share one or more contexts. For example, multiple executable containers that share access to a virtual disk can be assembled into a pod 717 (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod). In various implementations a pod represents a set of running or runnable processes. A pod can be deployed as the lowest level executable unit of a containerized application. As used herein, a pod that is instanced within a node can be addressed by a local IP address.

FIG. 7C depicts a virtualized controller implemented by a daemon-assisted containerized architecture 7C00. The containerized architecture comprises a collection of interconnected components suitable for implementing embodiments of the present disclosure and/or for use in the herein-described environments. Moreover, the shown daemon-assisted containerized architecture includes a user executable container instance 770 in configuration 751₃ that is further described below as pertaining to user executable container instance 770. Configuration 751₃ includes a daemon layer 737 that performs certain functions of an operating system.

User executable container instance 770 comprises any number of user containerized functions (e.g., user containerized function1 760₁, user containerized function2 760₂, . . . , user containerized functionN 760₃). Such user containerized functions can execute autonomously or can be interfaced with or wrapped in a runnable object to create a runnable instance (e.g., runnable instance 758). In some cases, the shown operating system components 778 comprise portions of an operating system, which portions are interfaced with or included in the runnable instance and/or any user containerized functions. In this embodiment of a daemon-assisted containerized architecture, the computing platform 706 might or might not host operating system components other than operating system components 778. More specifically, the shown daemon might or might not host operating system components other than operating system components 778 of user executable container instance 770.

The virtual machine architecture 7A00 of FIG. 7A and/or the containerized architecture 7B00 of FIG. 7B and/or the daemon-assisted containerized architecture 7C00 of FIG. 7C can be used in any combination to implement a distributed platform that contains multiple servers and/or nodes that manage multiple tiers of storage where the tiers of storage might be formed using the shown data repository 731 and/or any forms of network accessible storage. As such, the multiple tiers of storage may include storage that is accessible over communications link 715. Such network accessible storage may include cloud storage or networked storage (NAS) and/or may include all or portions of a storage area network (SAN). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term “vDisk” refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor or corresponding computer modules that manages the interactions between the underlying hardware and user virtual machines or containers that run client software.

Distinct from user virtual machines or user executable containers, a special controller virtual machine or a special controller executable container can be used to manage certain storage and I/O activities. Such a special controller virtual machine is referred to as a “CVM”, or as a controller executable container, or as a service virtual machine (SVM), or as a service executable container, or as a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 7D depicts a distributed virtualization system in a multi-cluster environment 7D00. The shown distributed virtualization system is configured to be used to implement the herein disclosed techniques. Specifically, the distributed virtualization system of FIG. 7D comprises multiple clusters (e.g., cluster 783₁, . . . , cluster 783_{N}) comprising multiple nodes that have multiple tiers of storage in a storage pool. Representative nodes (e.g., node 781₁₁, . . . , node 781_{1M}) and storage pool 790 associated with cluster 783₁ are shown. Each node can be associated with one server, multiple servers, or portions of a server. The nodes can be associated (e.g., logically and/or physically) with the clusters. As shown, the multiple tiers of storage include storage that is accessible through a network 796, such as a networked storage 786 (e.g., a storage area network or SAN, network attached storage or NAS, etc.). The multiple tiers of storage further include instances of local storage (e.g., local storage 791₁₁, . . . , local storage 791_{1M}). For example, the local storage can be within or directly attached to a server and/or appliance associated with the nodes. Such local storage can include solid state drives (SSD 793₁₁, . . . , SSD 793_{1M}), hard disk drives (HDD 794₁₁, . . . , HDD 794_{1M}), and/or other storage devices.

As shown, any of the nodes of the distributed virtualization system can implement one or more user virtualized entities (VEs) such as the virtualized entity (VE) instances shown as VE 788₁₁₁, . . . , VE 788_{11K}, . . . , VE 788_{1M1}, . . . , VE 788_{1MK}, and/or a distributed virtualization system can implement one or more virtualized entities that may be embodied as a virtual machines (VM) and/or as an executable container. The VEs can be characterized as software-based computing “machines” implemented in a container-based or hypervisor-assisted virtualization environment that emulates underlying hardware resources (e.g., CPU, memory, etc.) of the nodes. For example, multiple VMs can operate on one physical machine (e.g., node host computer) running a single host operating system (e.g., host operating system 787₁₁, . . . , host operating system 787_{1M}), while the VMs run multiple applications on various respective guest operating systems. Such flexibility can be facilitated at least in part by a hypervisor (e.g., hypervisor instance 785₁₁, . . . , hypervisor instance 785_{1M}), which hypervisor instances are logically located between the various guest operating systems of the VMs and the host operating system of the physical infrastructure (e.g., node).

As an alternative, executable containers may be implemented at the nodes in an operating system-based virtualization environment or in a containerized virtualization environment. The executable containers comprise groups of processes and/or may use resources (e.g., memory, CPU, disk, etc.) that are isolated from the node host computer and other containers. Such executable containers directly interface with the kernel of the host operating system (e.g., host operating system 787₁₁, . . . , host operating system 787_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 790 by the VMs and/or the executable containers.

Multiple instances of such virtualized controllers can coordinate within a cluster to form the distributed storage system 792 which can, among other operations, manage the storage pool 790. This architecture further facilitates efficient scaling in multiple dimensions (e.g., in a dimension of computing power, in a dimension of storage space, in a dimension of network bandwidth, etc.).

A particularly-configured instance of a virtual machine at a given node can be used as a virtualized controller in a hypervisor-assisted virtualization environment to manage storage and I/O (input/output or IO) activities of any number or form of virtualized entities. For example, the virtualized entities at node 781₁₁ can interface with a controller virtual machine (e.g., virtualized controller 782₁₁) through hypervisor instance 785₁₁ to access data of storage pool 790. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 792. For example, a hypervisor at one node in the distributed storage system 792 might correspond to software from a first vendor, and a hypervisor at another node in the distributed storage system 792 might correspond to a second software vendor. As another virtualized controller implementation example, executable containers can be used to implement a virtualized controller (e.g., virtualized controller 782_{1M}) in an operating system virtualization environment at a given node. In this case, for example, the virtualized entities at node 781_{1M} can access the storage pool 790 by interfacing with a controller container (e.g., virtualized controller 782_{1M}) through hypervisor instance 785_{1M} and/or the kernel of host operating system 787_{1M}.

In certain embodiments, one or more instances of an agent can be implemented in the distributed storage system 792 to facilitate the herein disclosed techniques. Specifically, agent 784₁₁ can be implemented in the virtualized controller 782₁₁, and agent 784_{1M} can be implemented in the virtualized controller 782_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

Solutions attendant to deploying container-attached storage modules in an isolated subnet (distinct from the subnet of an encapsulating virtual private cloud) can be brought to bear through implementation of any one or more of the foregoing techniques. Moreover, any aspect or aspects of container-attached storage modules having advanced capabilities can be implemented in the context of the foregoing environments.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A deployment into a cloud-provided host network, the deployment comprising:
an underlay network, the underlay network being formed of one or more routers of the cloud-provided host network and the underlay network forming an isolated namespace that is distinct from namespaces of the cloud-provided host network;
a container-attached storage module that is situated within the underlay network, wherein container-attached storage module operates within the isolated namespace; and
a network interface component that facilitates network access to the container-attached storage module via a static IP address that is configured into the network interface component.

2. The deployment of claim 1, wherein communication between components within the namespaces of the cloud-provided host network communicate with components within the isolated namespace via a pair of virtual ethernet interfaces (veth).

3. The deployment of claim 1, wherein communication between a first operating system pod of a first worker node and a second operating system pod of a second worker node communicate over the underlay network without incurring a network address translation by the one or more routers of the cloud-provided host network.

4. The deployment of claim 3, wherein the underlay network is a cloud-provided subnet that hosts operating system pods and wherein the cloud-provided host network hosts application pods.

5. The deployment of claim 1, wherein the container-attached storage module is implemented as a Kubernetes pod.

6. The deployment of claim 1, wherein the underlay network is configured using a container networking interface plug-in that includes both a native configuration path as well as a custom container-attached storage module configuration path.

7. The deployment of claim 1, wherein the cloud-provided host network is hosted on a public cloud.

8. The deployment of claim 1, wherein the cloud-provided host network is hosted on an on-prem private cloud.

9. A method for forming an underlay onto a cloud-provided host network, the method comprising:
establishing an underlay network, the underlay network being formed of one or more routers of the cloud-provided host network and the underlay network forming an isolated namespace that is distinct from namespaces of the cloud-provided host network;
instantiating a container-attached storage module that is situated within the underlay network, wherein container-attached storage module operates within the isolated namespace; and
configuring a network interface component that facilitates network access to the container-attached storage module via a static IP address that is configured into the network interface component.

10. The method of claim 9, wherein communication between components within the namespaces of the cloud-provided host network communicate with components within the isolated namespace via a pair of virtual ethernet interfaces (veth).

11. The method of claim 9, wherein communication between a first operating system pod of a first worker node and a second operating system pod of a second worker node communicate over the underlay network without incurring a network address translation by the one or more routers of the cloud-provided host network.

12. The method of claim 11, wherein the underlay network is a cloud-provided subnet that hosts operating system pods and wherein the cloud-provided host network hosts application pods.

13. The method of claim 9, wherein the container-attached storage module is implemented as a Kubernetes pod.

14. The method of claim 9, wherein the underlay network is configured using a container networking interface plug-in that includes both a native configuration path as well as a custom container-attached storage module configuration path.

15. A non-transitory computer readable medium having stored thereon a sequence of instructions which, when stored in memory and executed by one or more processors causes the one or more processors to perform a set of acts for forming an underlay onto a cloud-provided host network, the set of acts comprising:
establishing an underlay network, the underlay network being formed of one or more routers of the cloud-provided host network and the underlay network forming an isolated namespace that is distinct from namespaces of the cloud-provided host network;
instantiating a container-attached storage module that is situated within the underlay network, wherein container-attached storage module operates within the isolated namespace; and
configuring a network interface component that facilitates network access to the container-attached storage module via a static IP address that is configured into the network interface component.

16. The non-transitory computer readable medium of claim 15, wherein communication between components within the namespaces of the cloud-provided host network communicate with components within the isolated namespace via a pair of virtual ethernet interfaces (veth).

17. The non-transitory computer readable medium of claim 15, wherein communication between a first operating system pod of a first worker node and a second operating system pod of a second worker node communicate over the underlay network without incurring a network address translation by the one or more routers of the cloud-provided host network.

18. The non-transitory computer readable medium of claim 17, wherein the underlay network is a cloud-provided subnet that hosts operating system pods and wherein the cloud-provided host network hosts application pods.

19. The non-transitory computer readable medium of claim 15, wherein the container-attached storage module is implemented as a Kubernetes pod.

20. The non-transitory computer readable medium of claim 15, wherein the underlay network is configured using a container networking interface plug-in that includes both a native configuration path as well as a custom container-attached storage module configuration path.
